(19) United States
(12) Patent Application Publication
(10) Pub. No.: US 2014/0021755 A1
(43) Pub. Date: Jan. 23, 2014

(54) CAR SEAT

(71) Applicants: Jayson Wayne Oates, West Leederville (AU); Edward Joseph Khoury, Bateman (AU)

(72) Inventors: Jayson Wayne Oates, West Leederville (AU); Edward Joseph Khoury, Bateman (AU)

(21) Appl. No.: 14/110,097

(22) PCT Filed: Mar. 30, 2012
(86) PCT No.: PCT/AU12/00333

§ 371 Date: Oct. 4, 2013

(30) Foreign Application Priority Data
Apr. 4, 2011 (AU) 2011901232

(51) Int. Cl. B60N 2/28

(52) U.S. Cl. CPC B60N 2/28
USPC 297/219.1

(57) ABSTRACT

Described is an inflatable car seat that provides for easy transport and inflation as well as providing suitable fixings for secure installation in a vehicle. The car seat includes an elongate pump housing including an air pump, and first and second inflatable members each secured to the pump housing along a portion of the length thereof. Operation of the air pump inflates the first inflatable member to form a base portion of the car seat, and inflates the second inflatable member to form a rear portion of the car seat.

### BACKGROUND OF THE INVENTION

(1) Field of Invention

The present invention relates to a car seat and, more particularly, to an inflatable car seat, that provides for easy transport and inflation as well as providing suitable fixings for secure installation in a vehicle.

(2) Description of Related Art

Car seats provide increased safety for children in vehicles and are, therefore, required by law in many countries. In the case of travelling in your own vehicle, parents of small children generally have car seats permanently fitted. There are many instances, however, when it is required to travel with a child in another vehicle that may not have a car seat available. For example, in the case of a family travelling on holiday, it is common to travel in taxis or hire cars that may not have a car seat available. In such cases, either a car seat must be prearranged at the location or carried for the trip. Given that car seats are generally quite bulky, carrying a car seat can be problematic. Also, in some countries, vehicles such as taxis are not legally required to carry a car seat and it can, therefore, be difficult to book such a vehicle with a car seat.

Some inflatable car seats have been proposed that provide an alternative to standard car seats. These car seats can be inflated for use and then deflated to allow easier transportation. Such car seats generally must be inflated prior to use either by mouth or a separate pump in the standard manner of many inflatable type devices.

Thus, a continuing need exists for an inflatable car seat that provides for easy transport and inflation as well as providing suitable fixings for secure installation in a vehicle.

### SUMMARY OF THE INVENTION

The present invention relates to a car seat and, more particularly, to an inflatable car seat that provides for easy transport and inflation as well as providing suitable fixings for secure installation in a vehicle.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a top, perspective-view illustration of a car seat in an inflated configuration in accordance with the present invention;

FIG. 2a is a top, perspective-view illustration of the car seat of FIG. 1 in accordance with the present invention;

FIG. 2b is a side-view illustration of the car seat of FIG. 1 in accordance with the present invention;

FIG. 2c is an illustration of an enlarged view of Detail A of FIG. 2b in accordance with the present invention;

FIG. 3 is a top, perspective-view illustration of the ear seat of FIG. 1 in a deflated configuration in accordance with the present invention;

FIG. 4a is a top, perspective-view illustration of the car seat of FIG. 1 in a closed configuration within a carry case in accordance with the present invention;

FIG. 4b is a bottom, perspective-view of the ear seat of FIG. 1 in the closed configuration in accordance with the present invention;

FIG. 5a is a bottom-view illustration of the car seat in the closed configuration in accordance with the present invention;

FIG. 5b is a side-view illustration of the car seat in the closed configuration in accordance with the present invention;

FIG. 5c is an end-view illustration, of the car seat in the closed configuration in accordance with the present invention;

FIG. 6a is a side-view illustration of the car seat in the closed configuration in accordance with the present invention;

FIG. 6b is a cross-sectional view illustration of the car seat of FIG. 6a through the line B-B in accordance with the present invention;

FIG. 7 is an exploded-view illustration of the components of the car seat of FIG. 1 in accordance with the present invention;

FIG. 8a is an end-view illustration of a pump housing of the car seat of FIG. 1 in accordance with the present invention;

FIG. 8b is a bottom-view illustration of the pomp housing of the car seat of FIG. 1 in accordance with the present invention;

FIG. 8c is a side-view illustration of the pump housing of the car seat of FIG. 1 in accordance with the present invention;

FIG. 8d is a first perspective-view illustration of the pump housing of the car seat of FIG. 1 in accordance with the present invention;

FIG. 8e is a second perspective-view illustration of the pump housing of the car seat of FIG. 1 in accordance with ihe present invention;

FIG. 9 is an exploded-view illustration of the pump housing of the car seat of FIG. 1 in accordance with the present invention;

FIG. 10a is an end-view illustration of the pump housing in accordance with the present invention;

FIG. 10b is a side, cross-sectional view illustration of the pump housing of FIG. 10a through the line C-C in accordance with the present invention;

FIG. 11 is an top, perspective view of the pump housing showing operation of the pump in accordance with the present invention;

FIG. 12 illustrates a view of the car seat placed on the seat of a vehicle in accordance with the present invention;

FIG. 13 is an illustration showing attachment of a top securing strap of the car seat in accordance with the present invention;

FIG. 14 is an illustration showing the car seat in use supporting a child in accordance with the present invention;

FIG. 15 is an illustration showing the seat belt of the vehicle secured across the child in the car seat in accordance with the present invention;

FIG. 16a is a front-view illustration of the child in the car seat in accordance with the present invention; and

FIG. 16b is a side-view illustration of the child in the car seat in accordance with the present invention.

### DETAILED DESCRIPTION

The present invention relates to a car seat and, more particularly, to an inflatable car seat that provides for easy transport and inflation as well as providing suitable fixings for secure installation in a vehicle. The following description is presented to enable one of ordinary skill in the art to make and use the invention and to incorporate it in the context of particular applications. Various modifications, as well as a variety of uses, in different applications will be readily apparent to those skilled in the art, and the general principles defined herein may be applied to a wide range of embodiments. Thus, the present invention is not intended to be limited to the embodiments presented, but is to be accorded with the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Please note, if used, the labels left, right, front, back, top, bottom, forward, reverse, clockwise and counter-clockwise have been used for convenience purposes only and are not intended to imply any particular fixed direction. Instead, they are used to reflect relative locations and/or directions between various portions of an object. As such, as the present invention is changed, the above labels may change their orientation.

(1) Specific Details

Referring to the figures there is shown a car seat 10. The car seat 10 comprises an inflatable seat provided with a carry case 12 into which the car seat 10 is stored when in a deflated configuration.

The car seat 10 comprises, generally, a pump housing 14, a first inflatable member 16, and a second inflatable member 18. The first inflatable member 16 is provided to form the base portion of the car seat 10 on which the child will sit in use. The second inflatable member 18 is provided to form the rear portion of the car seat 10 against which the back of the child leans in use.

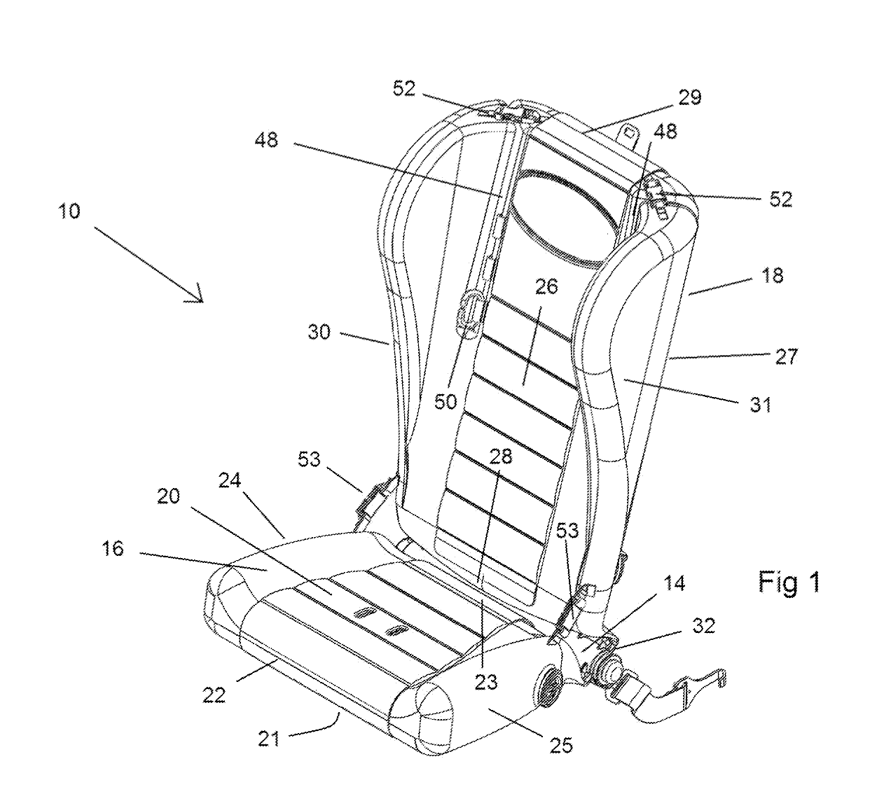

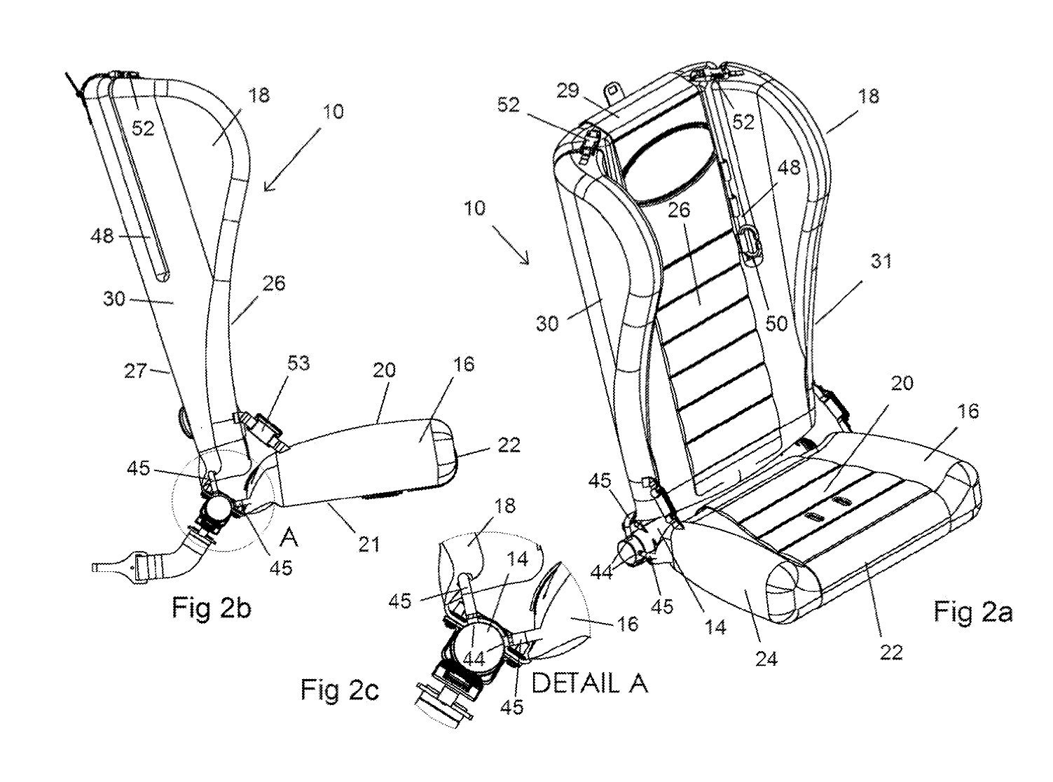

Referring to FIG. 1, the first inflatable member 16 comprises an upper surface 20 on which the child sits and an opposed lower surface 21. A front edge surface 22 joins the upper and lower surfaces 20 and 21 and is positioned forwardly in use, and a rear edge surface 23 joins the upper and lower surfaces 20 and 21 on sides remote from the front edge surface 22. First and second side edge surfaces 24 and 25 join the upper and lower surfaces 20 and 21 from the rear edge surface 23 to the front edge surface 22.

The second inflatable member 18 comprises a front surface 26 on which the child leans in use and an opposed rear surface 27. A lower edge surface 28 joins the front and rear surfaces 26 and 27, and a top edge surface 29 joins the front and rear surfaces 26 and 27 on sides remote from the lower edge surface 28. First and second side edge surfaces 30 and 31 join the front and rear surfaces 26 and 27 from the lower edge surface 28 to the upper edge surface 29.

In the aspect shown, the first and second inflatable members 16 and 18 are integrally formed such that the rear edae surface 23 of the first inflatable member 16 is connected to the lower edge surface 28 of the second inflatable member 18. An interconnecting web portion 32 is provided connecting the first and second inflatable members 16 and 18.

The pump housing 14 is secured to both the first and second inflatable members 16 and 18. The pump housing 14 comprises an elongate housing, and the first and second inflatable members 16 and 18 are each secured along at least a portion of the length of the pump housing 14. The first inflatable member 16 is secured to the pump housing 14 adjacent the rear edge surface 23, and the second inflatable member 18 is secured to the pump housing 14 adjacent the lower edge surface 28.

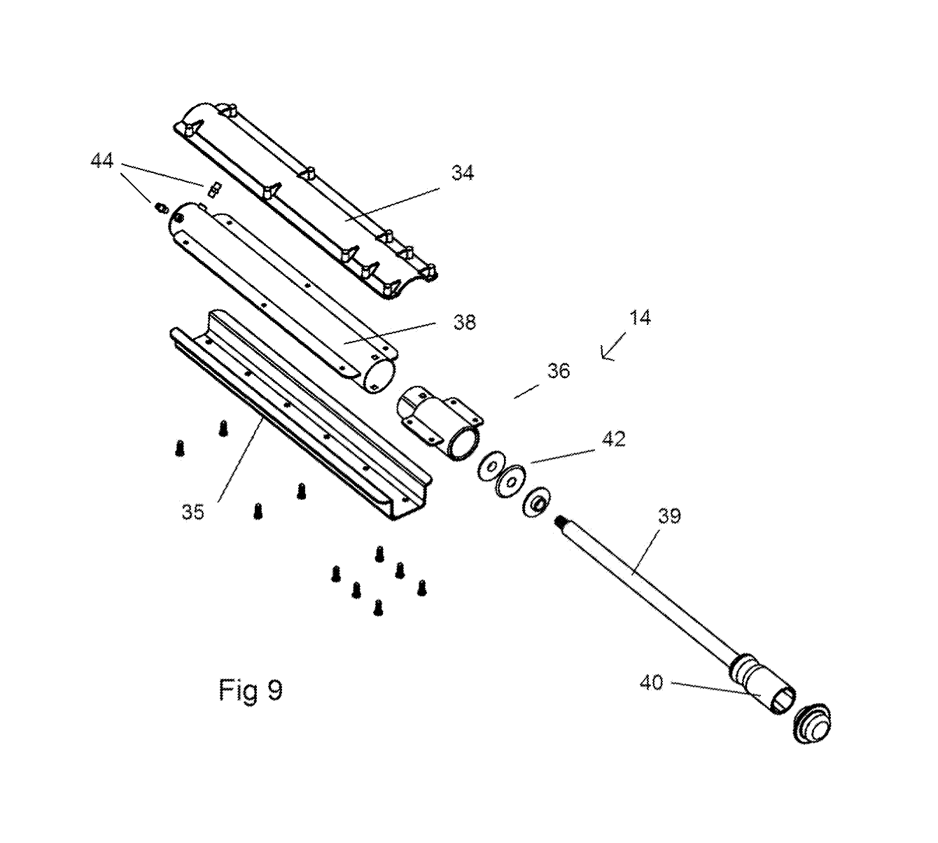

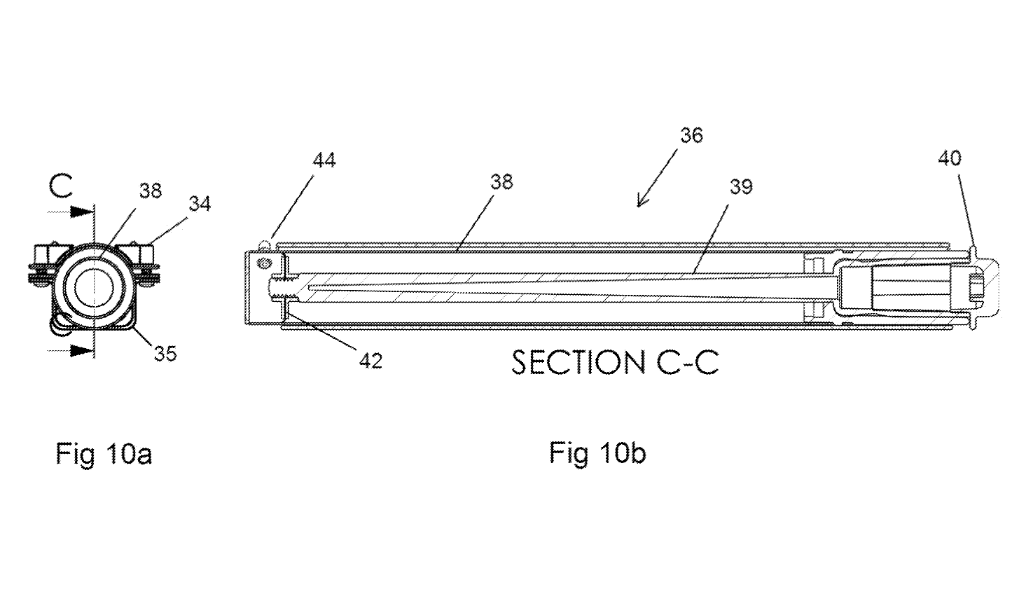

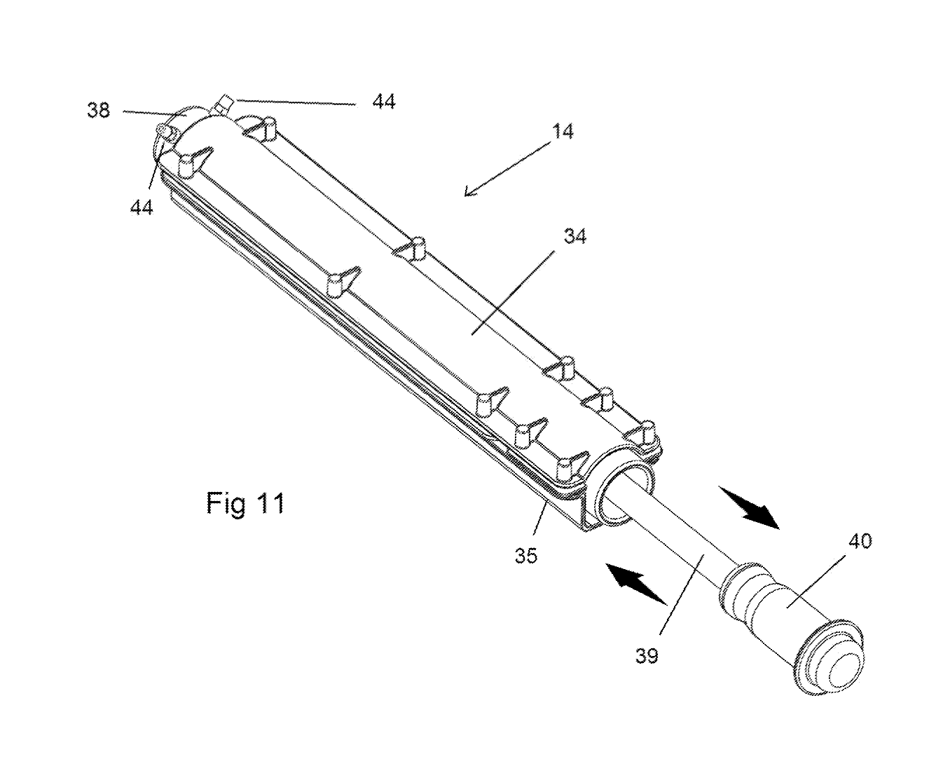

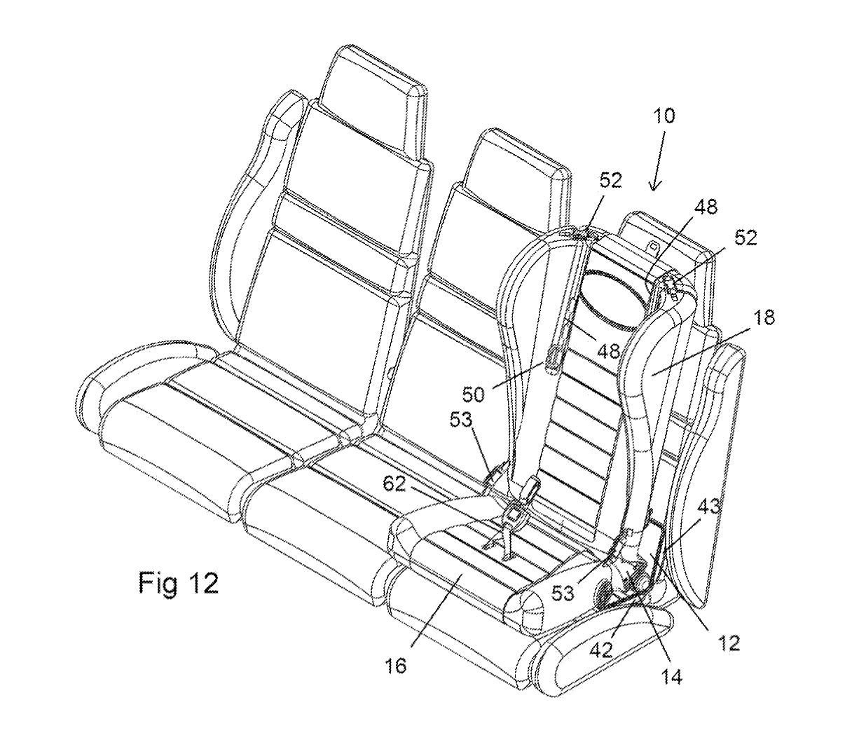

In the aspect shown, the pump housing 14 includes an upper housing portion 34 and a lower housing portion 35 (as best seen in FIG. 9). Between the upper and lower housing portions 34 and 35 is provided an air pump 36, lite air pump 36 comprises a hollow pump body 38 into which is received a piston 39. The air pump 36 operates to pump air to inflate the first and second inflatable members 16 and 18 in a manner similar to a standard bicycle pump.

The first and second inflatable members 16 and 18 are secured to the pump housing 14 by the interconnecting web portion 32. The interconnecting web portion 32 is received between the upper and lower housing portions 34 and 35 such that when the upper housing portion 34 is secured to the lower housing portion 35 by suitable securing means (a non-limiting example of which includes securing screws), the interconnecting web portion 32 is fixed relative to the pump housing 14.

The piston 39 is received in a first end of the pump body 38 and includes a handle 40 on a first outer end thereof such that the handle 40 can be gripped to pull the piston 39 out of the cylindrical pump body 38. The piston 39 includes a disc 42 adjacent a second inner end thereof to seal across the pump body 38. A one-way valve arrangement is provided in the manner of a standard bicycle pump such that as the handle 40 is drawn outwardly, air is drawn into the pump body 38 and when the handle 40 is pushed inwardly the air inside the pump body 38 is compressed by the disc 42.

The pump body 38 includes a pair of outlets 44 adjacent an end thereof remote from the handle 40. The outlets 44 are connected via air hoses 45 to the first and second inflatable members 16 and 18. Therefore, by operating the air pump 36, air is pumped into the first and second inflatable members 16 and 18 to form the base and rear of the car seat 10.

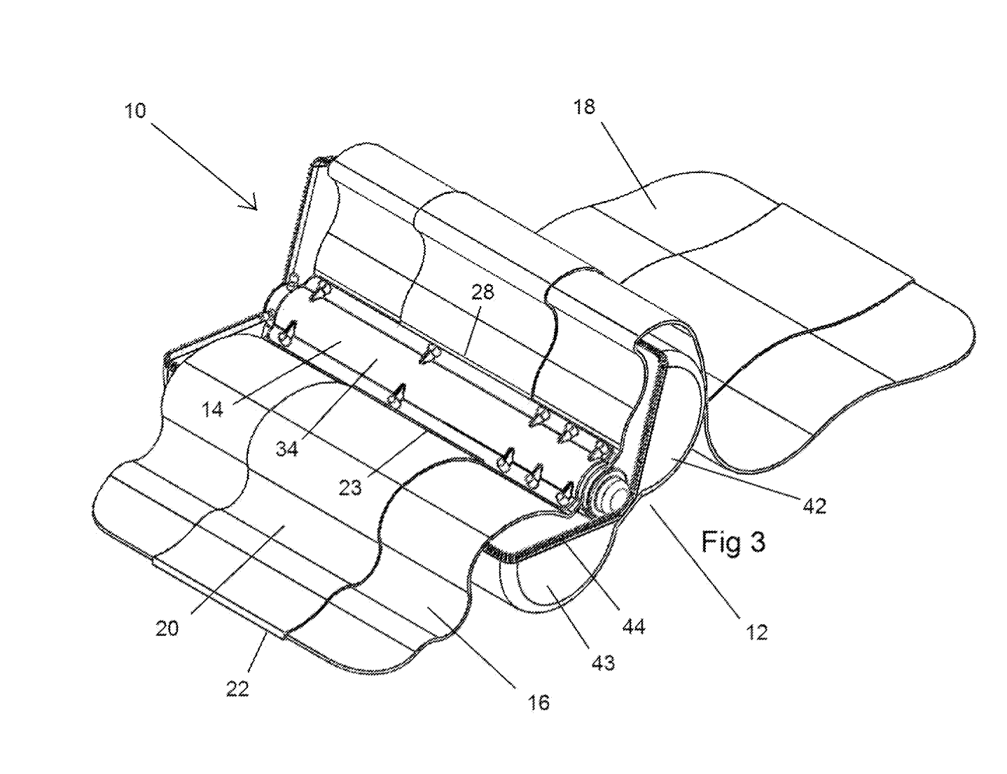

As shown in FIG. 3, as first and second inflatable members 16 and 18 inflate, the pump housing 14 is contained between the interconnecting web portion 32, the rear edge surface 23 of the first inflatable member 16, and the lower edge surface 28 of the second inflatable member 18. In this location, a child sitting on the car seat 10 is held clear of the pump housing 12 by the inflatable members 16 and 18, providing a comfortable sitting position for the child. Also, the handle of the pump 40 is still accessible on one side of the car seat 10 so that it may be operated should further inflation be required.

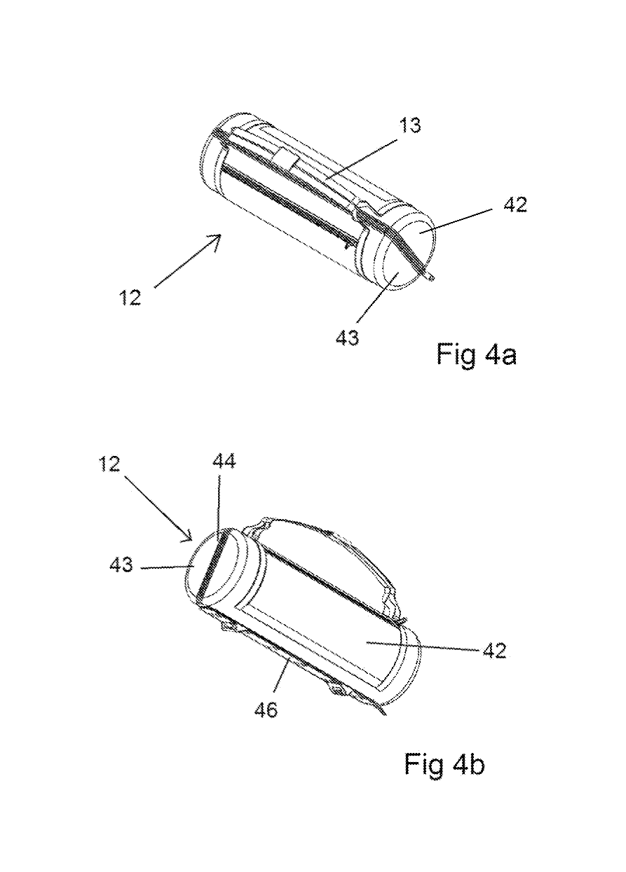

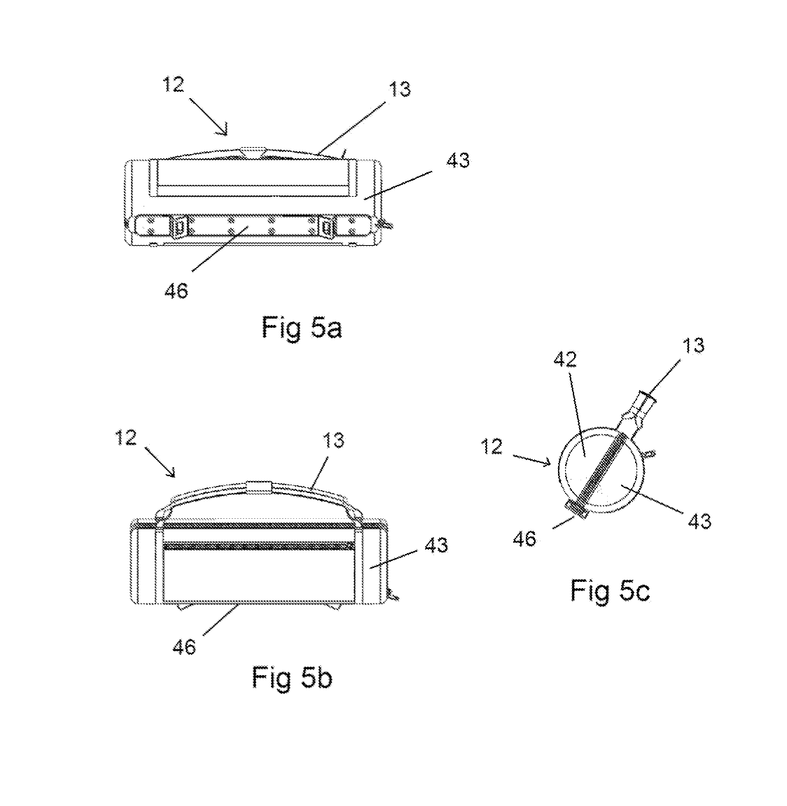

The carry case 12 comprises a cylindrical case having an upper case half 42 and a lower case half 43. The upper case half 42 and the lower case half 43 are joined along longitudinal sides thereof such that the case 12 can pivot between an open configuration (as shown in FIG. 3) and a closed configuration (as shown in FIGS. 4-6). A zipper 44 is provided to join the first and second case halves 42 and 43 in the closed configuration.

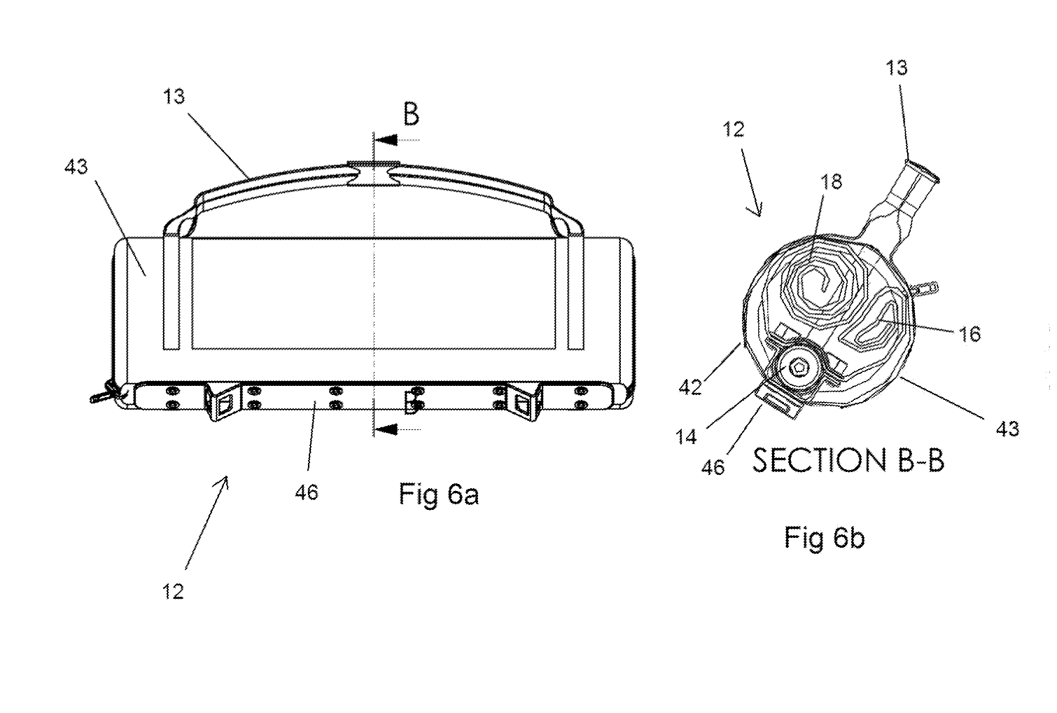

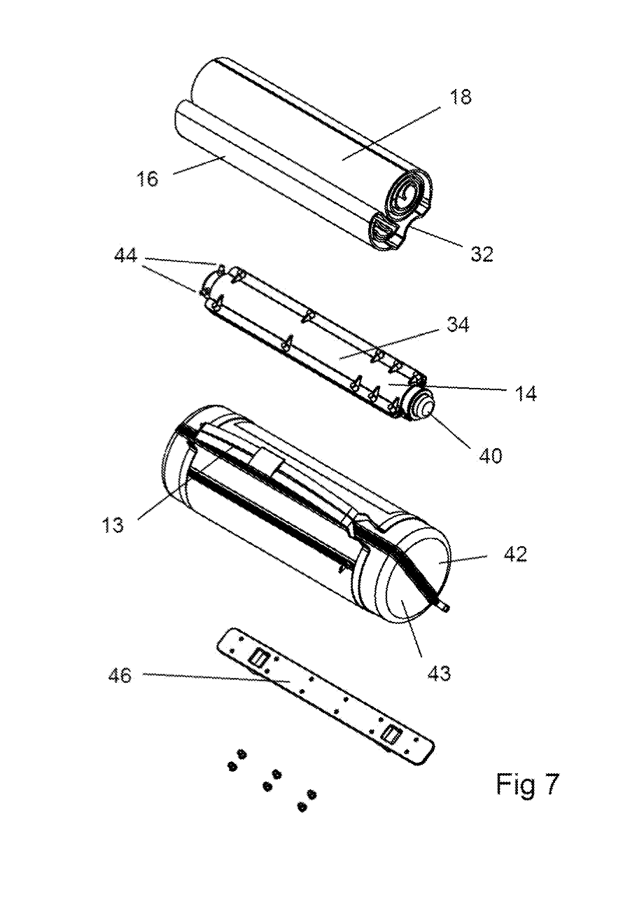

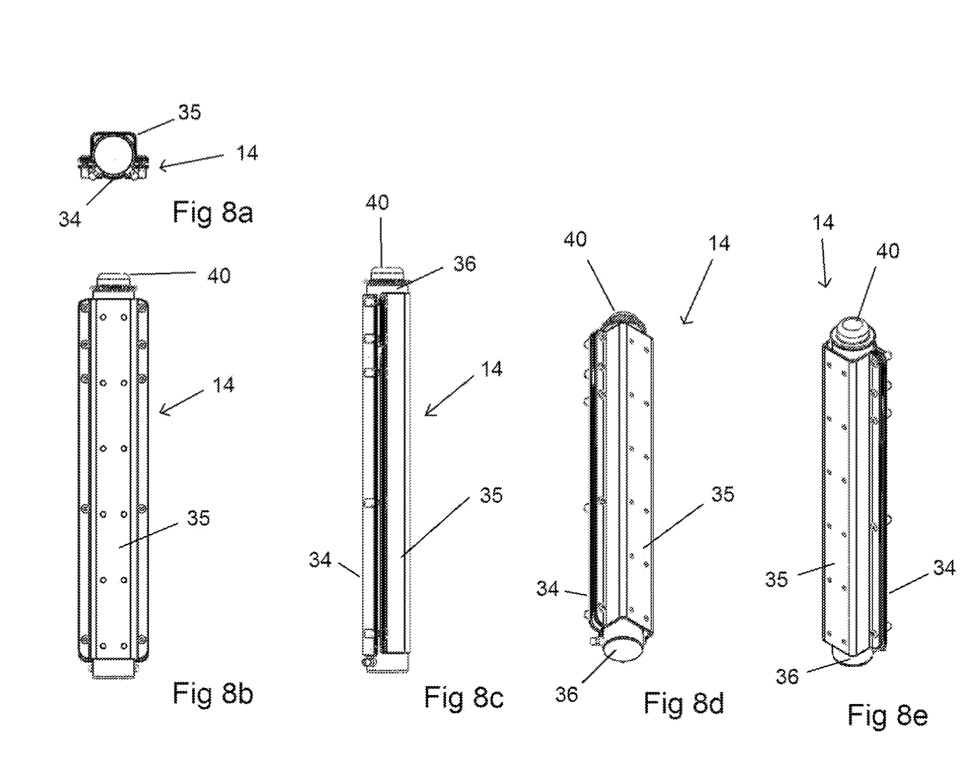

The pump housing 14 is located in use adjacent the connection between the upper and lower case halves 42 and 43 such that, when the case halves 42 and 43 are pivoted to the closed configuration, the pump housing 14 is located within the carry case 12. The first and second inflatable members 16 and 18 may also be stored within the carry case 12 in a deflated configuration by roiling them up into cylinders as shown in FIG. 6.

A base plate 46 is provided adjacent the connection between the upper and lower ease halves 42 and 43 on the outside of the case 12 and is secured to the pump housing 14 through the case 12, The base plate 46 provides a securing point for the car seat 10 to the seat of the vehicle. Opposed ends of the base plate 46 are provided with connection clips suitable for securing to anchoring points (e.g., ISOFIX) within the vehicle.

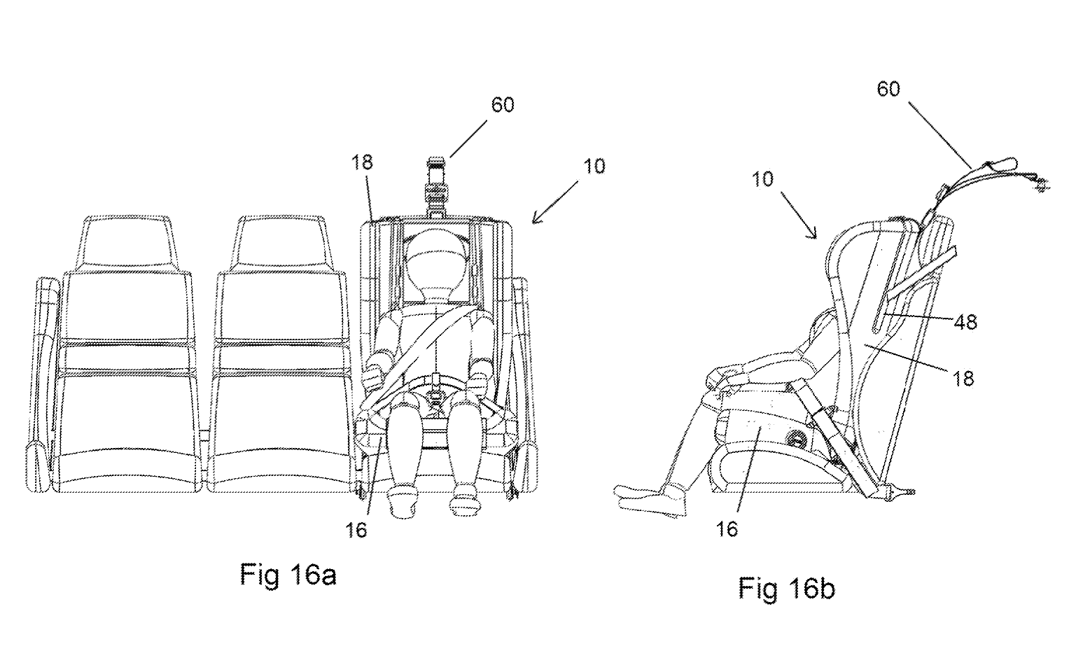

The second inflatable member 18 also includes belt slots 48 for receiving portions of a vehicle seat belt. A first belt slot 48 is provided extending inwardly from the upper edge surface 29 of the second inflatable member 18 downwardly towards the lower edge surface 28 adjacent the first side edge surface 30. A second belt slot 48 is provided extending inwardly from the upper edge surface 29 of the second inflatable member 18 downwardly towards the lower edge surface 28 adjacent the second side edge surface 30. As shown in FIG. 16b, one of the belt slots 48 receives the upper part of the seatbek of the vehicle. Clips 50 are provided adjacent, each of the belt slots 48 to secure the seatbelt. The clips 50 are connectable at a plurality of locations along the length of the belt slots 48 in order to position the seatbelt at the correct height.

Securing straps 52 are provided on the upper edge surface 29 of the second inflatable member 18 to secure sides of the belt slots 48 together. Further securing straps 53 are also provided to secure the first inflatable member 16 to the second inflatable member 18. A first securing strap 53 extends from the first side edse surface 24 of the first inflatable member 16 to the first side edae 30 of the second inflatable member 18, and a second securing strap 53 extends from the second side ecke surface 25 of the first inflatable member 16 to the second side edge surface 31 of the second inflatable member 18.

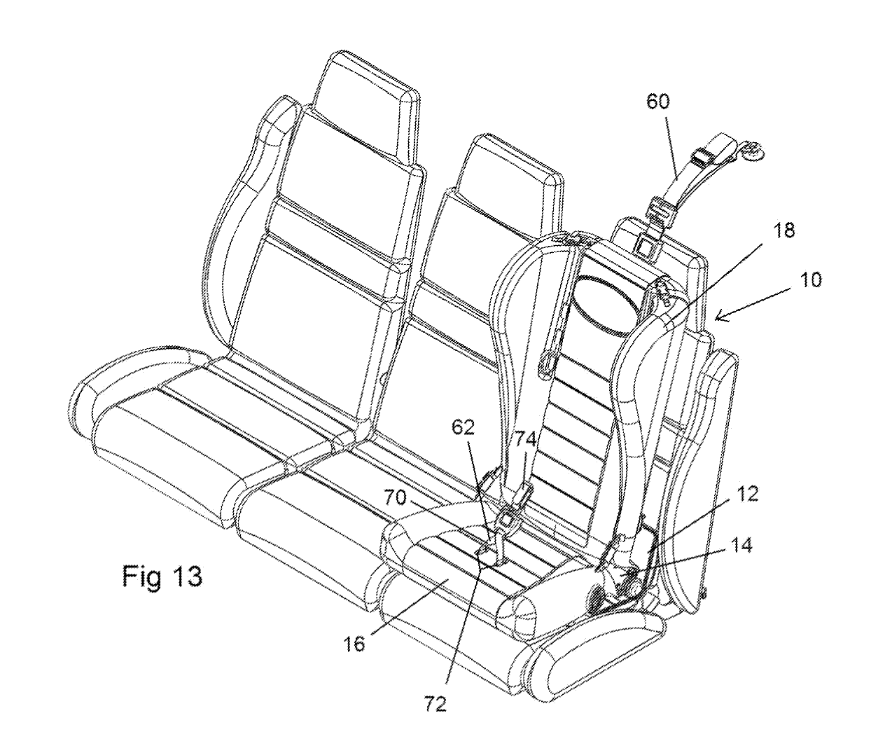

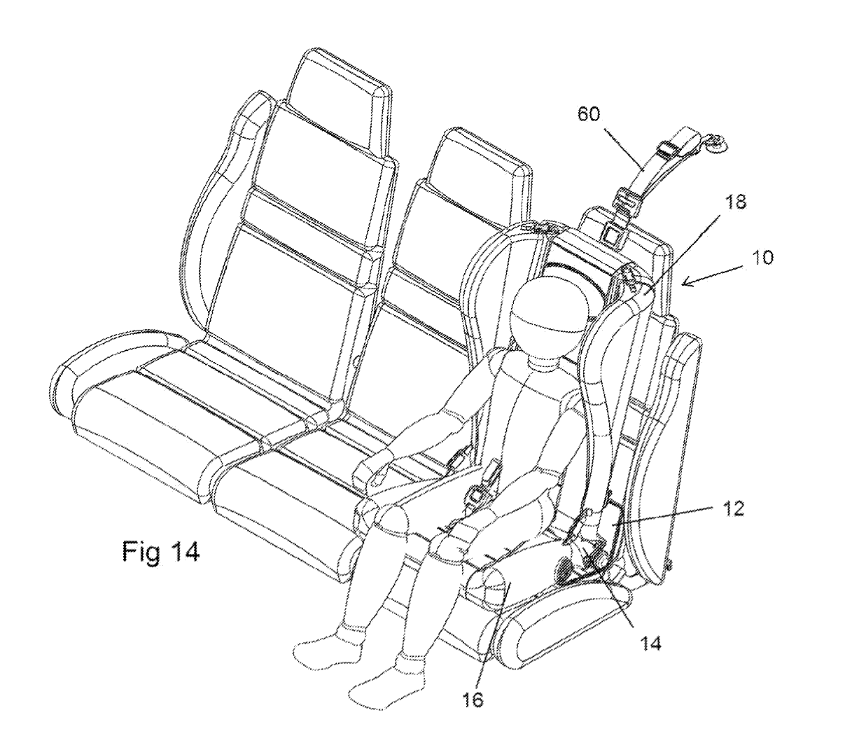

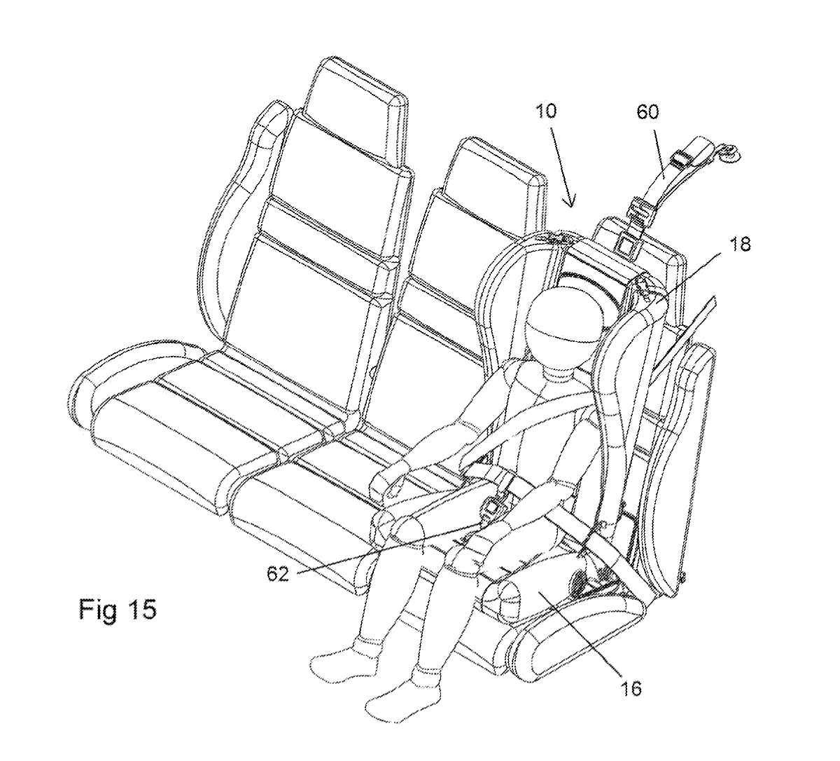

In use, the inflatable car seat 10 can be easily transported in the carry case 12 which is provided with a suitable carry strap 13. When the car seat 10 is required for use, the case 12 is opened and inflated by means of the integral air pump 36. The securing clips on the base plate 40 can be used to secure to, for example, ISOFIX anchor points in the vehicle. An upper securing strap 60 (as shown in FIGS. 13-16b) may also be secured to an upper anchor point in the vehicle.

The seat belt of the car may then be passed across the child and secured with the shoulder strap received in the belt slot 48. This ensures the shoulder strap is located at the correct height over the shoulder of the child. The lap portion of the vehicle seat belt, is then connected to a lap belt 62 provided on the base of the car seat 10 (as shown in Figs. 13-16b). The lap belt 68 comprises a lower belt portion 70, ends extending downwardly through a pair of apertures 72 in the base portion of the car seat 10. The lap belt 62 includes a securing loop 74 through which the lap portion of the seatbelt can be passed. This arrangement retains the lap portion of the seatbelt down over the lap to prevent it moving up over the lower abdomen and prevents the child in the car seat sliding forward or “submarining”.

It will be readily apparent to persons skilled in the relevant arts that various modifications and improvements may be made to the foregoing embodiments, in addition to those already described, without departing from the basic inventive concepts of the present invention.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. A car seat comprising;
an elongate pump housing including an air pump;
a first inflatable member secured to the pump housing along a portion of the length thereof; and
a second inflatable member secured to the pump housing along a portion of the length thereof;
wherein operation of the air pump inflates the first inflatable member to form a base portion of the car seat and inflates the second inflatable member to form a rear portion of the car seat.

19. The car seat in accordance with claim 18, wherein the pump housing is secured adjacent a rear edge surface of the first inflatable member and a lower edge surface of the second inflatable member.

20. The car seat in accordance with claim 19, wherein the rear edge surface of the first inflatable member is secured to the lower edge surface of the second inflatable member by an interconnecting web portion and the interconnecting web portion is secured to the pump housing.

21. The car seat in accordance with claim 20, wherein when the base portion and rear portion are inflated, the pump housing is contained between the interconnecting web portion, the rear edge surface of the first inflatable member and the lower edge surface of the second inflatable member.

22. The car seat in accordance with claim 18, wherein the air pump comprises an elongate hollow pump body into which is received a piston, wherein the piston can be moved in and out of the pump body to pump air into the first and second inflatable members.

23. The car seat in accordance with claim 22, wherein the air pump includes a handle for operation of the pump, the handle being accessible from a side of the car seat adjacent the connection between the base portion and the rear portion.

24. The car seat in accordance with claim 23, wherein the pump housing comprises an upper housing portion and a lower housing portion between which the pump body is secured and the interconnecting web portion is received between the upper and lower housing portions such that when the upper housing portion is secured to the lower housing portion, the first inflatable member extends from a first side of the pump housing and the second inflatable member extends from a second side of the pump housing.

25. The car seat in accordance with claim 24, wherein the pump body includes one or more outlets adjacent an end thereof remote from the handle, the outlets being connected via air hoses to the first and second inflatable members.

26. The car seat in accordance with claim 18, wherein the pump housing is secured to an inner surface of a carry case such that when the first and second inflatable members are deflated, the first and second, inflatable members and the pump housing can be contained within the cany case.

27. The car seat in accordance with claim 26, wherein the carry case comprises a cylindrical case having an upper case half and a lower case half joined along longitudinal sides thereof such that the case can pivot between an open configuration and a closed configuration.

28. The car seat in accordance with claim 27, wherein the pump housing is secured within the carry case adjacent the connection between the upper and lower case halves such that when the case halves are pivoted to the closed configuration, the pump housing and the deflated first and second in datable members are located within the carry case.

29. The car seat in accordance with claim 28, wherein a base plate is provided adjacent the connection between the upper and lower case halves on the outside of the case and is secured to the pump housing through the case.

30. The car seat in accordance with claim 29, wherein opposed ends of the base plate are provided with connection clips suitable for securing to ISOFIX anchoring points within a vehicle.

31. The car seat in accordance with claim 18, wherein the first inflatable member comprises an upper surface, an opposed lower surface, a front edge surface joining the upper and lower surfaces and first and second side edge surfaces joining the upper and lower surfaces, and wherein the second inflatable member comprises a front surface, an opposed, rear surface, a top edge surface and first and second side edge surfaces join the front and rear surfaces.

32. The car seat in accordance with claim 31, wherein a first belt slot is provided extending downwardly from the upper edge surface of the second inflatable member adjacent the first side edge surface of the second inflatable member and a second belt slot is provided extending downwardly horn the upper edge surface of the second inflatable member adjacent the second side edge surface of the second inflatable member.

33. The ear seat in accordance with claim 32, wherein clips are provided adjacent each of the belt slots to secure the seatbelt, the clips being connectabie at a plurality of locations along the length of the belt slots.
